(19) United States
(12) Patent Application Publication
(10) Pub. No.: US 2012/0200201 A1
(43) Pub. Date: Aug. 9, 2012

(54) SPINDLE MOTOR

(75) Inventor: Jin San KIM, Suwon (KR)

(73) Assignee: SAMSUNG ELECTRO-MECHANICS CO., LTD., Suwon (KR)

(21) Appl. No.: 13/339,611

(22) Filed: Dec. 29, 2011

(30) Foreign Application Priority Data
Feb. 8, 2011 (KR) 10-2011-0010991

(51) Int. Cl. H02K 5/00

(52) U.S. Cl. 310/67 R

(57) ABSTRACT

There is provided a spindle motor including: a base member having a sleeve housing extended upwardly therefrom; a sleeve mounted in the sleeve housing to rotatably support a shaft and having a fixing part formed on an outer circumferential surface thereof; and a stator core fixedly mounted on the fixing part to be disposed between the fixing part and the sleeve housing and having an upper surface of one end thereof contacting and fixed to the fixing part.

### CROSS-REFERENCE TO RELATED APPLICATIONS

This application claims the priority of Korean Patent Application No. 10-2011-0010991 filed on Feb. 8, 2011, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor including a stator generating rotational force through electromagnetic interaction with a magnet.

2. Description of the Related Art

Generally, a spindle motor is mounted in an information recording and reproducing device such as a hard disk drive (HDD), or the like. In accordance with the trend for a high capacity recording and reproducing device having the spindle motor mounted therein, the demand for improvement in rotational precision during the driving of the spindle motor has been increased.

Further, in accordance with an increase in the demands placed on the hard disk drive used in a notebook computer, a tablet computer, or the like, the demand for improvement in quality for noise limitation has been increased correspondly.

Meanwhile, rotational force generated by driving the spindle motor is generated through electromagnetic interaction between a magnet, which is a component of a rotor, and a stator core, which is a component of a stator. In other words, the rotational force rotating the recording disk is induced on opposite surfaces of the magnet, which is the component of the rotor, and the stator core, which is the component of the stator.

Therefore, a lack of balance in the axial and circumferential distance of the magnet and the stator core causes imbalance in the rotational force, such that rotational precision is deteriorated.

According to the related art, an assembly precision of six components, that is, a core, a base, a sleeve, a shaft, a rotor case, and a magnet is reflected in the rotational precision. In addition, the core and the base, which are manufactured in a mold, have a lower processing precision, as compared to a mechanically processed products.

As described above, the assembly precision of a plurality of components is reflected in the rotational precision and products manufactured in a mold have a low processing precision, such that rotational precision is deteriorated.

Further, vibrations and noise occur due to the deterioration of rotational precision.

### SUMMARY OF THE INVENTION

An aspect of the present invention provides a spindle motor in which assembly precision of a stator core and a magnet may be improved.

Another aspect of the present invention provides a spindle motor in which assembly quality of a stator core and a magnet may be confirmed in an assembly state thereof.

Another aspect of the present invention provides a spindle motor in which rotational torque generated by interaction between a stator core and a magnet may be increased.

Another aspect of the present invention provides a spindle motor in which vibrations and noise generated during the driving thereof may be reduced.

According to an aspect of the present invention, there is provided a spindle motor including: a base member having a sleeve housing extended upwardly therefrom; a sleeve mounted in the sleeve housing to rotatably support a shaft and having a fixing part formed on an outer circumferential surface thereof; and a stator core fixedly mounted on the fixing part to be disposed between the fixing part and the sleeve housing and having an upper surface of one end thereof contacting and fixed to the fixing part.

The fixing part may be formed as a protrusion protruding outwardly in a radial direction and having a rectangular cross section.

One end of the stator core may be inserted into a space formed by the fixing part and the sleeve housing, and an inner circumferential surface of the stator core may be fixed to the outer circumferential surface of the sleeve.

The fixing part may have a guiding part on a bottom thereof, the guiding part guiding a mounting position of the stator core when the stator core is mounted thereon, and the stator core may have a corresponding part on an upper surface thereof such that the corresponding part corresponds to the guiding part.

The guiding part may be formed as a groove recessed from the bottom of the fixing part, and the corresponding part may be formed as an insertion protrusion inserted into the guiding part formed as the groove.

A bottom of the stator core may be disposed to be spaced apart from an upper surface of the sleeve housing by a predetermined distance, and a space between the stator core and the upper surface of the sleeve housing may be filled with an adhesive.

The spindle motor may further include a rotor case mounted on an upper end of the shaft to thereby rotate together with the shaft, wherein the rotor case may include a magnet mounting part extended downwardly in an axial direction from an edge thereof and having a magnet mounted on an inner circumferential surface thereof.

The rotor case may include a protrusion extended from the rotor case so as to be disposed to be opposite to the fixing part to thereby support the fixing part during external impact.

The shaft, the sleeve, the stator core, and the rotor case may be mounted in the sleeve housing formed on the base member in an integrally assembled state thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a spindle motor according to an exemplary embodiment of the present invention;

FIG. 2 is a partially enlarged cross-sectional view of a spindle motor shown in FIG. 1;

FIG. 3 is a view describing a state in which components configuring a spindle motor are coupled before they are mounted on a base member; and

FIG. 4 is a cross-sectional view schematically showing a spindle motor according to another exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Moreover, detailed descriptions related to well-known functions or configurations will be ruled out in order not to unnecessarily obscure subject matters of the present invention.

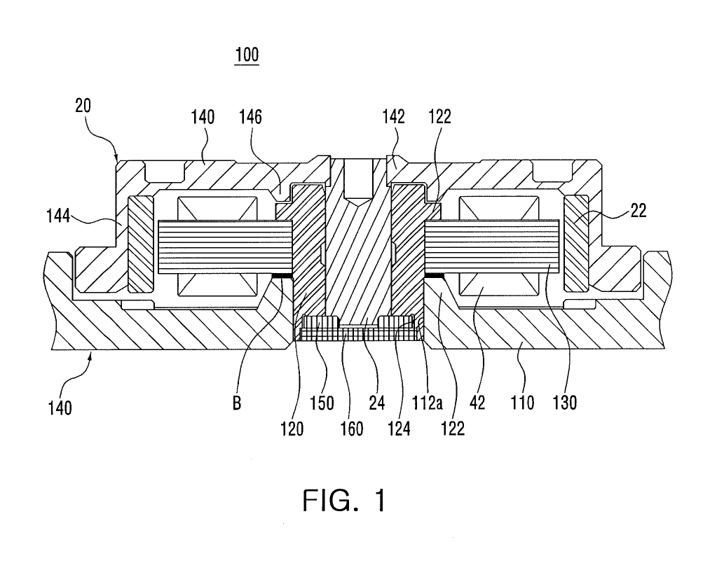

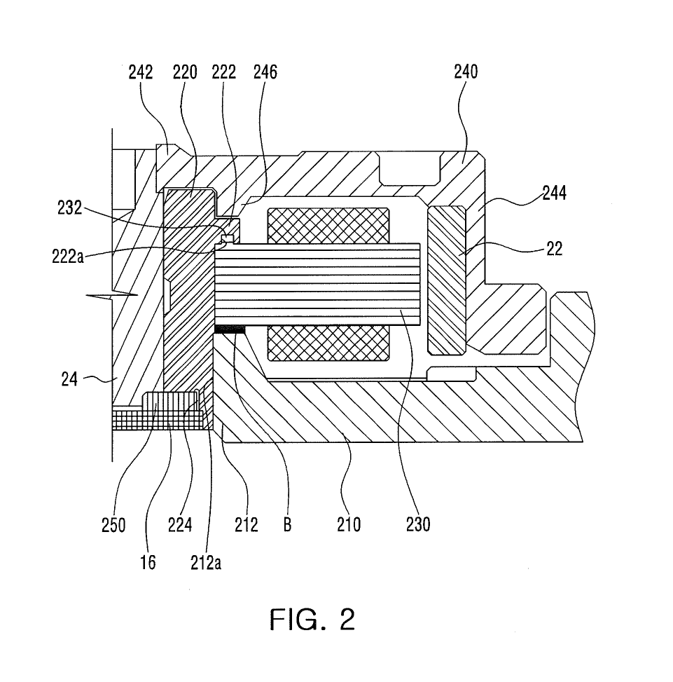

FIG. 1 is a cross-sectional view schematically showing a spindle motor according to an exemplary embodiment of the present invention; and FIG. 2 is a partially enlarged cross-sectional view of the spindle motor of FIG. 1.

Referring to FIGS . 1 and 2, a spindle motor 100 according to an exemplary embodiment of the present invention may be configured to include abase member 110, a sleeve 120, a stator core 130, and a rotor case 140.

Meanwhile, the spindle motor 100 may be a motor used in a recording disk driving device rotating a recording disk, and include a rotor 20 and a stator 40.

The rotor 20 includes a cup-shaped rotor case 140 of which inner circumferential portion is provided with a magnet 25 having an annular ring shape corresponding to the stator core 130. The magnet 22 having the annular ring shape may be a permanent magnet in which an N pole and an S pole are alternately magnetized in a circumferential direction to generate magnetic force having a predetermined strength.

In addition, the rotor case 140 may include a rotor hub 142 connected to a shaft 24 and a magnet mounting part 144 having the magnet 22 having the annular ring shape disposed on an inner surface thereof.

Meanwhile, the stator 40, which refers to all fixed members with the exception of a rotating member, may be configured to include the stator core 130, a winding coil 42 enclosing the stator core 130, the base member 110, and a sleeve housing 112 extended from the base member 110.

The magnet 22 provided on an inner circumferential surface of the magnet mounting part 144 is disposed to be opposite to the winding coil 42, and the rotor 20 rotates through the electromagnetic interaction of the magnet 22 and the winding coil 42. In other words, when the rotor case 140 rotates, the shaft 24 rotates together with the rotor case 140.

Meanwhile, terms with regard to directions are defined as follows. When being viewed from FIG. 1, an axial direction refers to a vertical direction based on the shaft 24, a radial direction refers to a direction towards an outer edge of the rotor case 140 based on the shaft 24 or a central direction of the shaft 24 based on the outer edge of the rotor case 140, and a circumferential direction refers to a direction of rotation along an outer circumferential surface of the shaft 24.

The base member 110 includes the sleeve housing 112 extended upwardly therefrom. That is, the base member 110 includes the sleeve housing 112 extended upwardly in the axial direction so that the sleeve 120 maybe fixedly mounted thereon.

In other words, the sleeve housing 112 is provided with a mounting hole 112a for mounting the sleeve 120, and the sleeve 120 is insertedly mounted within the mounting hole 122a.

In addition, an upper surface of the sleeve housing 112 may be formed to be flat in order to fix the stator core 130 thereto.

Further, the base member 110 may be manufactured in a mold. For example, the base member 110 maybe manufactured by a die casting scheme or a pressing scheme.

The sleeve 120 is mounted in the sleeve housing 112 to rotatably support the shaft 24, and includes a fixing part 122 formed on an outer circumferential surface thereof.

The fixing part 122 is formed on an upper portion of the outer circumferential surface of the sleeve 120. In addition, the fixing part 122 may be formed as a protrusion protruding outwardly in the radial direction and having a rectangular cross section.

More specifically, the fixing part 122 and the sleeve housing 112 have a predetermined space formed therebetween.

That, the predetermined space having a groove shape is formed between the fixing part 122 and the sleeve housing 112.

Meanwhile, a lower portion of the sleeve 120 is fixed to the sleeve housing 112. In addition, a mounting part 124 in which a thrust plate 150 and a cover plate 160 are mounted may be provided inside the lower portion of the sleeve 120.

That is, the mounting part 124 may be formed as a stepped groove recessed upwardly from a bottom of the sleeve 120 and have the thrust plate 150 mounted on an upper portion thereof and the cover plate 160 disposed on a lower portion of the thrust plate 150.

The stator core 130 is fixedly mounted on the fixing part 122 so as to be disposed between the fixing part 122 and the sleeve housing 112, and has an upper surface of one end thereof contacting and fixed to the fixing part 122.

That is, one end of the stator core 130 is inserted into the space formed by the fixing part 122 and the sleeve housing 112, the upper surface of one end of the stator core 130 contacts a bottom of the fixing part 122, and an inner circumferential surface of the stator core 130 is fixed to the outer circumferential surface of the sleeve 120.

In addition, the stator core 130 may be fixedly mounted on the fixing part 122 and the sleeve 120 by an adhesive.

As such, the stator core 130 is mounted to contact the outer circumferential surface of the sleeve 120, such that a radial length of the stator core 130 may be increased. Therefore, the wining turns of the winding coil 42 wound around the stator core 130 may be increased to thereby increase torque generated during the driving of the spindle motor.

In other words, as compared to a case in which the stator core 130 is mounted to contact the outer circumferential surface of the sleeve housing 112, the radial length of the stator core 130 may be increased to thereby increase the torque generated during the driving of the spindle motor.

In addition, the upper surface of one end of the stator core 130 contacts the bottom of the fixing part 122 and the stator core 130 is mounted such that the inner circumferential surface thereof contacts the outer circumferential surface of the sleeve 120, whereby the radial and axial precision of the stator core 130 and the magnet 22 may be improved.

That is, radial precision, which is a precision for a mutually spaced distance between the stator core 130 and the magnet 22, may be improved. In addition, axial precision, which is a precision for positions of the center of the stator core 130 and the center of the magnet 22, may be improved.

Meanwhile, the bottom of the stator core 130 is disposed to be spaced apart from the upper surface of the sleeve housing 112 by a predetermined distance, and an adhesive B maybe filled between the stator core 130 and the upper surface of the sleeve housing 112.

That is, the adhesive B is filled between the stator core 130 and the sleeve housing 112 to thereby fix the stator core 130.

The adhesive B filled between the stator core 130 and the sleeve housing 112 serves to alleviate vibrations and noise generated during rotation of the rotor case 140, while serving to fix the stator core 130.

The rotor case 140 is mounted on an upper end of the shaft 24 to thereby rotate together with the shaft 24. In addition, as described above, the rotor case 140 may include the magnet mounting part 144 extended downwardly in the axial direction from an edge and having the magnet 22 mounted on the inner circumferential surface thereof.

Meanwhile, the rotor case 140 may include a protrusion 146 extended from the rotor case 140 so as to be disposed to be opposite to the fixing part 122 to thereby support the fixing part 122 during external impact.

That is, the protrusion 146 contacts the fixing part 122 of the sleeve 120 during the external impact to disperse a load applied to the fixing part 122, whereby separation or torsion of the stator core 130 may be reduced.

Meanwhile, the shaft 24 is insertedly mounted within the sleeve 120. The stator core 130 is mounted to contact the fixing part 122 of the sleeve 120, and the rotor case 140 is then mounted on the upper end of the shaft 24.

As such, since the stator core 130 is fixedly mounted on the sleeve 120, the assembly precision of the stator core 130 and the magnet 22 mounted in the rotor case 140 is confirmed, whereby the quality of the assembly precision may be managed.

That is, according to the related art in which the stator core 130 is mounted on the sleeve housing 112, since an assembly of the shaft 24, the sleeve 120, and the rotor case 140 should be mounted in the sleeve housing 112 of the base member 110, the assembly precision of the stator core 130 and the magnet 22 cannot but be indirectly measured, rather than being directly measured.

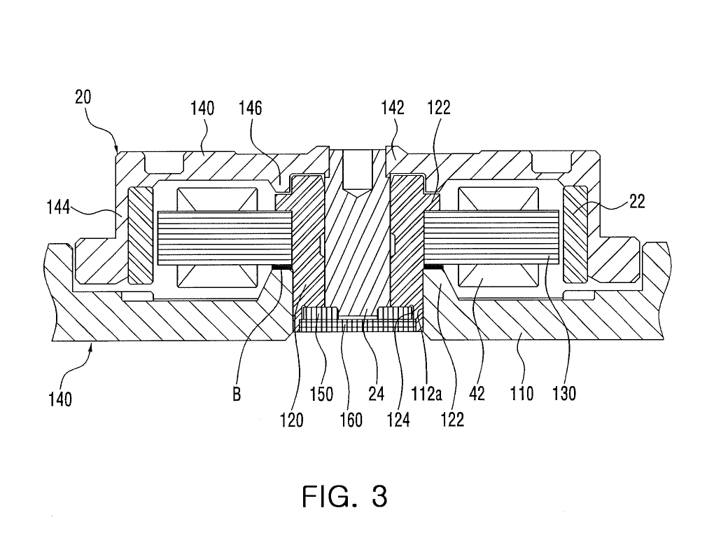

However, according to an exemplary embodiment, since the stator core 130 is fixedly mounted on the sleeve 120, as shown in FIG. 3, the assembly precision of the stator core 130 and the magnet 22 maybe directly measured through an assembly of the shaft 24, the sleeve 120, the stator core 130, and the rotor case 140.

Then, the assembly of the shaft 24, the sleeve 120, the stator core 130, and the rotor case 140 is mounted on the base member 110. Therefore, since the assembly precision may be confirmed, a level of quality management may be improved.

In addition, since a rotational precision of the magnet 22 and the stator core 130 is determined by an assembly precision of five components, that is, the stator core 130, the sleeve 120, the shaft 24, the rotor case 140, and the magnet 22, the rotational precision may be improved.

That is, as compared to a case in which the stator core 130 is mounted on the sleeve housing 112, influence by an assembly precision of the base member 110 is reduced, whereby rotational precision may be improved.

In addition, the base member 110, which is a product manufactured in a mold, is excluded from factors determining the assembly precision that determines the rotational precision, whereby deterioration of the rotational precision due to assembly tolerance may be reduced.

As a result, according to an exemplary embodiment of the present invention, since the assembly precision of the spindle motor 100 maybe improved, the rotational precision may be further improved.

As described above, the stator core 130 is fixedly mounted on the fixing part 122 of the sleeve 120, whereby the assembly precision of the stator core 130 and the magnet 22 may be improved. In addition, since the assembly quality of the stator core 130 and the magnet 22 may be directly confirmed in an assembly state, the level of quality management may be improved.

In addition, one end of the stator core 130 may be insertedly mounted in the space formed by the fixing part 122 of the sleeve 120 and the sleeve housing 112 to extend the radial length of the stator core 130, such that the winding turns of the winding coil 42 wounded around the stator core 130 may be increased, whereby rotational torque may be increased.

Furthermore, the adhesive is filled between the stator core 130 and the upper surface of the sleeve housing 112 to mount the stator core 130 in the sleeve housing 112, such that vibrations of the stator core 130 generated during the driving of the spindle motor may be buffered by the adhesive, whereby the generation of vibrations and noise may be reduced.

Hereinafter, a spindle motor according to another exemplary embodiment of the present invention will be described with reference to the accompanying drawings. However, a detailed description of the same components as the above-mentioned components will be omitted.

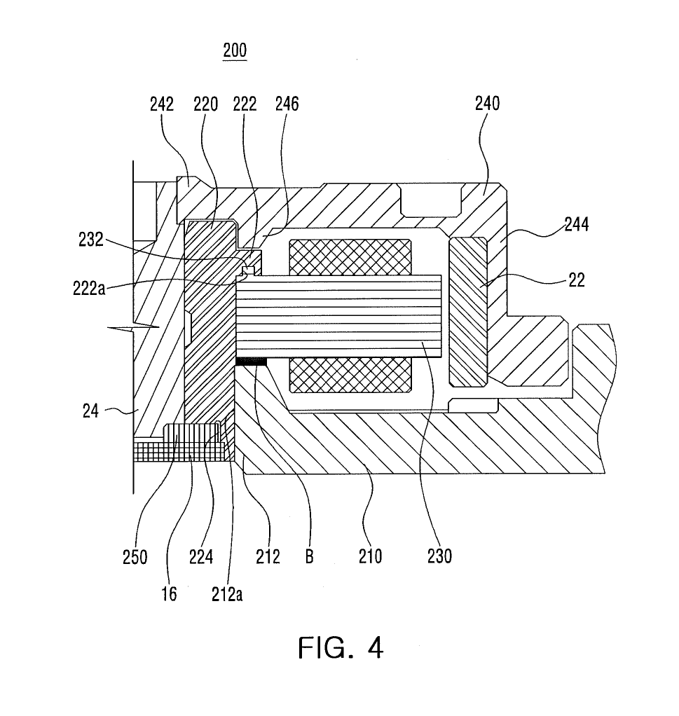

FIG. 4 is an enlarged cross-sectional view showing a spindle motor according to another exemplary embodiment of the present invention.

Referring to FIG. 4, a spindle motor 200 according to another exemplary embodiment of the present invention may be configured to include a base member 210, a sleeve 220, and a stator core 230.

Meanwhile, the base member 210 according to the present exemplary embodiment is the same as the base member 110 according to the above-mentioned exemplary embodiment. Therefore, a detailed description thereof will be omitted.

In addition, the sleeve 220 and the stator core 230 according to the present exemplary embodiment also are the same as the sleeve 120 and the stator core 130 according to the above-mentioned exemplary embodiment with the exception of configurations to be described below. Therefore, a detailed description thereof will be omitted.

The sleeve 220 may be provided with a fixing part 222, and a bottom of the fixing part 222 may be provided with a guiding part 222a guiding a mounting position of the stator core 230 when the stator core 230 is mounted thereon.

The guiding part 222a may be formed as a groove recessed upwardly from the bottom of the fixing part 222.

Meanwhile, an upper surface of the stator core 230 may be provided with a corresponding part 232 corresponding to the guiding part 222a.

The corresponding part 232 may be formed as an insertion protrusion protruding from the upper surface of the stator core 230 and inserted into the guiding part 222a formed as the groove.

As such, in the case in which the stator core 230 is closely mounted on the bottom of the fixing part 222 included in the sleeve 220, the corresponding part 232 of the stator core 230 is inserted into the guiding part 222a included in the bottom of the fixing part 222.

Therefore, the stator core 230 may be more precisely assembled with the sleeve 220, and the assembly of the stator core 230 and the sleeve 220 may be easily performed.

As set forth above, according to exemplary embodiments of the present invention, the stator core is fixedly mounted on the fixing part included in the sleeve, whereby the assembly precision of the stator core and the magnet may be improved. In addition, since the assembly quality of the stator core and the magnet may be directly confirmed in the assembly state thereof, the level of quality management may be improved.

Further, according to exemplary embodiments of the present invention, one end of the stator core maybe insertedly mounted in the space formed by the fixing part of the sleeve and the sleeve housing to extend the radial length of the stator core, such that the winding turns of the winding coil wounded around the stator core may be increased, whereby rotational torque may be increased.

Furthermore, the adhesive is filled between the stator core and the upper surface of the sleeve housing to couple the stator core to the sleeve housing, such that the vibrations of the stator core generated during the driving of the spindle motor may be buffered by the adhesive, whereby the generation of vibrations and noise may be reduced.

While the present invention has been shown and described in connection with the exemplary embodiments, it will be apparent to those skilled in the art that modification and variation can be made withough departing from the spirit and scope of the invention as defined by the appended claims.

What is claimed is:

1. A spindle motor comprising:
a base member having a sleeve housing extended upwardly therefrom;
a sleeve mounted in the sleeve housing to rotatably support a shaft and having a fixing part formed on an outer circumferential surface thereof; and
a stator core fixedly mounted on the fixing part to be disposed between the fixing part and the sleeve housing and having an upper surface of one end thereof contacting and fixed to the fixing part.

2. The spindle motor of claim 1, wherein the fixing part is formed as a protrusion protruding outwardly in a radial direction and having a rectangular cross section.

3. The spindle motor of claim 2, wherein one end of the stator core is inserted into a space formed by the fixing part and the sleeve housing, and
an inner circumferential surface of the stator core is fixed to the outer circumferential surface of the sleeve.

4. The spindle motor of claim 1, wherein the fixing part has a guiding part on a bottom thereof, the guiding part guiding a mounting position of the stator core when the stator core is mounted thereon, and
the stator core has a corresponding part on an upper surface thereof such that the corresponding part corresponds to the guiding part.

5. The spindle motor of claim 4, wherein the guiding part is formed as a groove recessed from the bottom of the fixing part, and
the corresponding part is formed as an insertion protrusion inserted into the guiding part formed as the groove.

6. The spindle motor of claim 1, wherein a bottom of the stator core is disposed to be spaced apart from an upper surface of the sleeve housing by a predetermined distance, and
a space between the stator core and the upper surface of the sleeve housing is filled with an adhesive.

7. The spindle motor of claim 1, further comprising a rotor case mounted on an upper end of the shaft to thereby rotate together with the shaft,
wherein the rotor case includes a magnet mounting part extended downwardly in an axial direction from an edge thereof and having a magnet mounted on an inner circumferential surface thereof.

8. The spindle motor of claim 7, wherein the rotor case includes a protrusion extended from the rotor case so as to be disposed to be opposite to the fixing part to thereby support the fixing part during external impact.

9. The spindle motor of claim 7, wherein the shaft, the sleeve, the stator core, and the rotor case are mounted in the sleeve housing formed on the base member in an integrally assembled state thereof.
